(19) United States
(12) Patent Application Publication
(10) Pub. No.: US 2011/0241411 A1
(43) Pub. Date: Oct. 6, 2011

(54) Alloy wheel protectors

(76) Inventor: Leo Nithas Fynn, Torquay (GB)

(21) Appl. No.: 13/066,010

(22) Filed: Apr. 5, 2011

Related U.S. Application Data
(63) Continuation-in-part of application No. 12/085,728, filed on May 29, 2008, now abandoned.

(30) Foreign Application Priority Data
Jun. 12, 2005 (GB) 05 24 834.9
Apr. 22, 2006 (GB) 06 07 999.0
Jun. 15, 2006 (GB) 06.11 835.0
Aug. 8, 2006 (GB) 06.15 697.0

(51) Int. Cl. B60B 7/01; B60B 7/06

(52) U.S. Cl. 301/37.24; 301/37.102

(57) ABSTRACT

A wheel protector for shielding the alloy wheel of a vehicle from impact damage includes an outer ring-shaped cover 4 forming a circumferential track, with an optional inner circular disc 1. A number of attachment elements 25 are slidably engaged with a track 4 to attach the cover to the outer tire rim of an alloy wheel by means of an adhesive layer. The attachment elements have a head portion 26 of part-circular cross section which is capable of limited angular movement within the track. The head portions snap-engage in the track 4 and are capable of sliding along the track to allow the wheel protector to rotate relative to the wheel upon impact with an object.

### CROSS-REFERENCE TO RELATED APPLICATION

This application is a continuation-in-part of copending U.S. patent application Ser. No. 12/085,728, filed May 29, 2008.

### TECHNICAL FIELD OF THE INVENTION

This invention relates to wheel protectors for use in shielding the alloy wheels of a vehicle against damage.

### BACKGROUND

Many, motor vehicles are fitted with alloy wheels. These have many attractions to vehicle owners. Apart from the fact that they have a “sporty” appearance, they are also lightweight and corrosion resistant. However, they can suffer badly from chips, scratches and other damage due to contact with edging stones, another vehicle wheel, a piece of flint or other hard object.

The present invention seeks to provide a new and inventive form of wheel protector which is very effective yet is easily fitted to a range of wheels whilst being easy to remove or replace when required.

### SUMMARY OF THE INVENTION

The present invention proposes an alloy wheel protector which includes a substantially disc-shaped cover having a plurality of attachment elements engaged with the cover at circumferentially-spaced positions for attaching the cover to an alloy wheel, in which the attachment elements can be adjusted to engage the cover at different circumferential positions.

The attachment elements are preferably slidably engaged with a track extending around at least part of the circumference of the cover.

### BRIEF DESCRIPTION OF THE DRAWINGS

The following description and the accompanying drawings referred to therein are included by way of non-limiting example in order to illustrate how the invention may be put into practice. In the drawings:

FIG. 1 shows an alloy wheel to which an alloy wheel protector in accordance with the invention has been fitted, as viewed from the outside;

FIG. 2 is an enlarged general view of one of the attachment elements shown in FIG. 1;

FIG. 3 is a sectional view showing the same attachment element engaged with a wheel cover; and

FIG. 4 is an exploded view of the wheel protector showing the wheel cover and attachment elements.

### DETAILED DESCRIPTION OF THE DRAWINGS

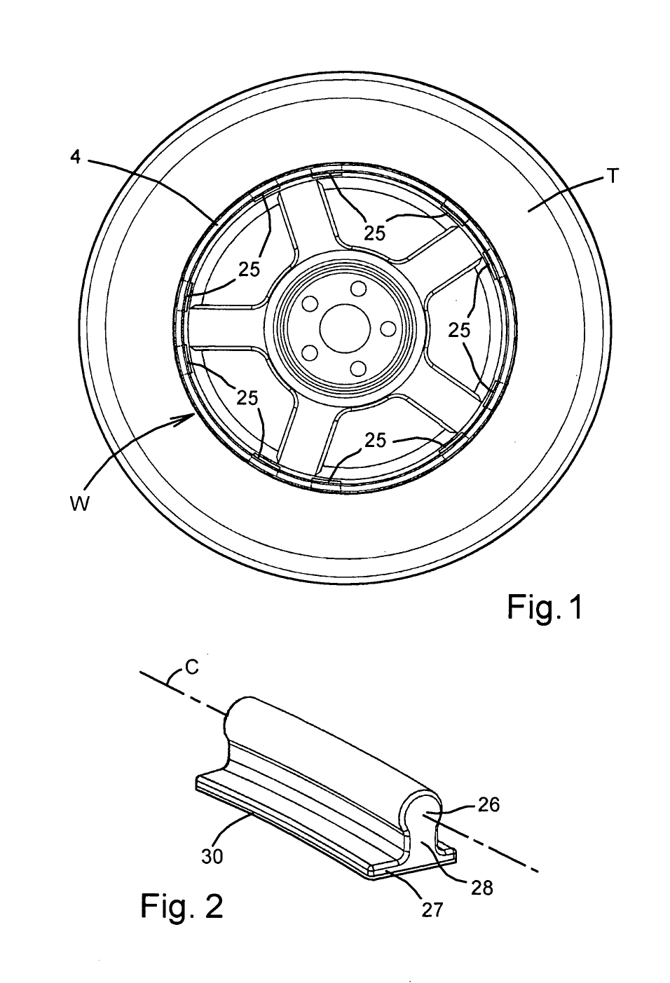

In this example the alloy wheel protector is fitted to a five-spoke alloy wheel W carrying a tire T. Referring to FIG. 1, the alloy wheel protector includes a circular ring-shaped cover 4 which is typically molded of a tough thermoplastic material. The ring-shaped cover is preferably transparent so that a wheel to which it is affixed will be visible through the cover, although opaque or coloured material could be used. The ring-shaped cover could also be provided with a decorative embellishment if desired. The diameter of the ring-shaped cover 4 is sufficient to cover the outer tire rim of the alloy wheel W without covering the tire T, but the wheel protectors can be manufactured in different diameters for use with different sizes of wheel. The ring-shaped cover 4 comprises a rearwardly-open channel of C-shaped transverse cross-section, forming a continuous molded circular track 4 extending around the full periphery of the cover.

Five pairs of attachment elements 25 are slidably engaged with the ring-shaped cover 4. The number and circumferential positions of the attachment elements can be varied to suit the configuration of the wheel W. The attachment elements may be formed of metal or similar thermoplastic to the ring-shaped cover 4, and are preferably transparent. Referring to FIG. 2, each attachment element is of elongate shape and, as seen in end view, includes a part-circular head 26, profiled for captive sliding engagement with the ring-shaped cover 4, which is joined to a flat base portion 27 by a neck portion 28.

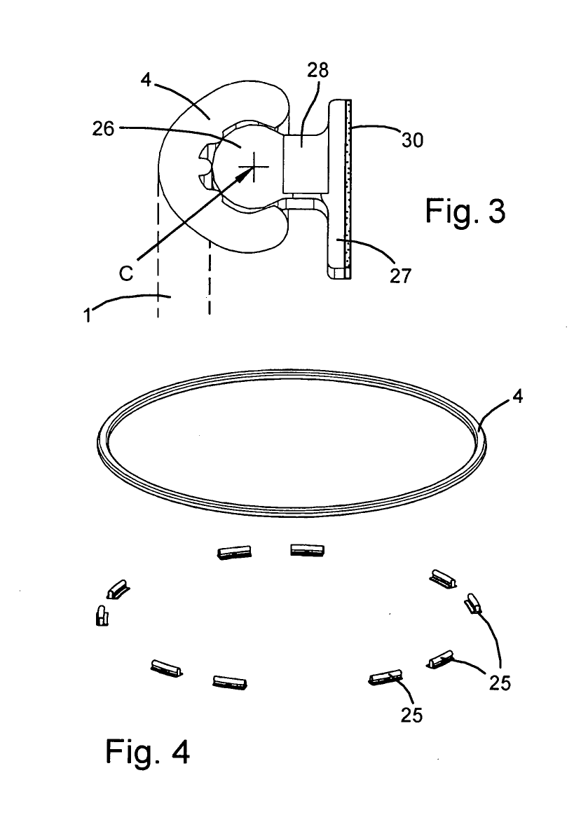

As shown in FIG. 3, the head 26 is snap-engaged in the C-shaped track formed by the ring-shaped cover 4 and, when engaged, is capable of limited angular rotational movement within the track 4 about longitudinal axis C of the head 26, which is shown in FIG. 2. In FIG. 3 the position of the longitudinal axis C is indicated at the intersection of two cross-lines.

The flat base portions 27 are bonded directly to the rim of an alloy wheel using an acrylic foam self-adhesive tape 30. The angular movement of the attachment elements referred to above allows the base portions to lie parallel to the adjacent surface of the wheel rim and thus ensures that a good bond is achieved. This method of semi-permanent attachment may be used with new or old vehicles provided the wheels are clean and undamaged.

The cover 4 is held sufficiently firmly to prevent significant movement during normal use. However, should the wheel come into contact with an edging stone or another hard object the alloy wheel protector absorbs the impact and protects the alloy wheel from damage. Since the attachment elements are able to slide easily along the track 4 the ring-shaped cover can rotate relative to both the wheel W and the attachment elements 25. This has been found to greatly reduce the risk of damage to the wheel. In effect, the ring-shaped cover remains stationary in contact with an impacted object, preventing contact between the object and the wheel, while the wheel continues to rotate. The resilient cushioning layer formed by the acrylic foam tape 30 also helps to protect the alloy surface during impacts.

The cover 4 can be temporarily removed by snap-disengaging the attachment elements from the cover.

Additional protection for the wheel may be obtained by optionally providing the cover with an integral disc 1 which fills the space inside the ring-shaped track 4, as indicated in dashed outline in FIG. 3. The disc is preferably transparent so that a wheel to which it is to be affixed will be visible through the cover, although opaque or coloured material could be used. The disc could also be provided with a decorative embellishment if desired. In practice, however, it has been found that the greatest protection is provided by the outer ring 4, and the amount of additional protection provided by the inner disc 1 is often nominal.

It will be appreciated that the features disclosed herein may be present in any embodiment of the invention in any feasible combination. Whilst the above description places emphasis on those areas which, in combination, are believed to be new, protection is sought for any inventive combination of the features disclosed herein.

1. An alloy wheel protector which includes a substantially circular cover providing a circumferentially-extending track of substantially c-shaped cross-section; and a plurality of attachment elements which are snap-engaged with the track at circumferentially-spaced positions for attaching the cover to an alloy wheel, in which each attachment element is of elongate shape and includes a head portion captively and slidingly engaged in the track, a neck portion, and a flat base portion; and a layer of self-adhesive material for attaching the base portion of each attachment element to the wheel; whereby, in the event of impact with a hard object, the sliding engagement between the attachment elements and the track allows relative movement to take place between the cover and the wheel.

2. An alloy wheel protector according to claim 1 in which the cover is formed of a transparent material.

3. An alloy wheel protector according to claim 1 in which the attachment elements are formed of a transparent material.

4. An alloy wheel protector according to claim 1 in which the head portion of each attachment element has a longitudinal axis and is capable of limited angular rotational movement about said longitudinal axis, within the track.

5. An alloy wheel protector according to claim 4 in which the head portion of each attachment element is of part-circular cross section, taken with respect to said longitudinal axis.

6. An alloy wheel protector according to claim 1 in which the cover includes an integral disc within said circumferentially-extending track.
